(19) United States
(12) Patent Application Publication
(10) Pub. No.: US 2025/0220037 A1
(43) Pub. Date: Jul. 3, 2025

(54) CONTAINER IMAGE GENEALOGY IN A COMPUTING SYSTEM

(71) Applicant: Sysdig, Inc., San Francisco, CA (US)

(72) Inventors: Dustin J. Nowak, Castle Rock, CO (US); Omer Azaria, San Francisco, CA (US)

(21) Appl. No.: 18/400,554

(22) Filed: Dec. 29, 2023

(51) Int. Cl. H04L 9/40; G06F 21/57

(52) U.S. Cl. CPC H04L 63/1433; G06F 21/577

(57) ABSTRACT

An example method of managing a container image in a computing system includes: adding, by first software executing on a host, metadata associated with a user to the container image, the metadata related to a set of software in the container image; receiving, by the first software or second software, the container image; scanning, by the first software or the second software, the container image to identify a software vulnerability; generating, by the first software or the second software, a mapping between the metadata and the software vulnerability; and assigning a remediation action to remediate the container image based on the mapping.

### BACKGROUND

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

A container is deployed and executed based on a container image. A container image is an executable software package that includes everything needed to run a container, including the code, runtime, system tools, system libraries, and settings. A container image includes, for example, application code, dependencies for the application code, runtimes needed for the application code, system tools and libraries, and an operating system (OS).

In an organizational setting, multiple different developers or teams may cooperate to generate a container image. One developer can add one part to an image while another developer can add another part to the image. Over time, a container image can become quite complex, having many parts developed by many different entities (developers, teams, etc.).

Software in a container image can contain bugs, malware, security vulnerabilities, and the like, which can be detected and become known after formation of the container image. However, it can be difficult to determine which developer(s), team(s), etc. were responsible for this software in the container image. This can complicate remediation of the container image to fix the vulnerable software.

### SUMMARY

In an embodiment, a method of managing a container image in a computing system is described. The method includes adding, by first software executing on a host, metadata associated with a user to the container image, the metadata related to a set of software in the container image; receiving, by the first software or second software, the container image; scanning, by the first software or the second software, the container image to identify a software vulnerability; generating, by the first software or the second software, a mapping between the metadata and the software vulnerability; and assigning a remediation action to remediate the container image based on the mapping.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a computing system according to embodiments.

FIG. 2 is a block diagram depicting data center according to embodiments.

FIG. 3 is a block diagram depicting a container imager according to embodiments.

FIG. 4 is a block diagram depicting logical operation of container security monitor according to embodiments.

FIG. 5 is a flow diagram depicting a method of creating or editing a container image according to embodiments.

FIG. 6 is a flow diagram depicting a method of processing a container image for software vulnerabilities according to embodiments.

### DETAILED DESCRIPTION

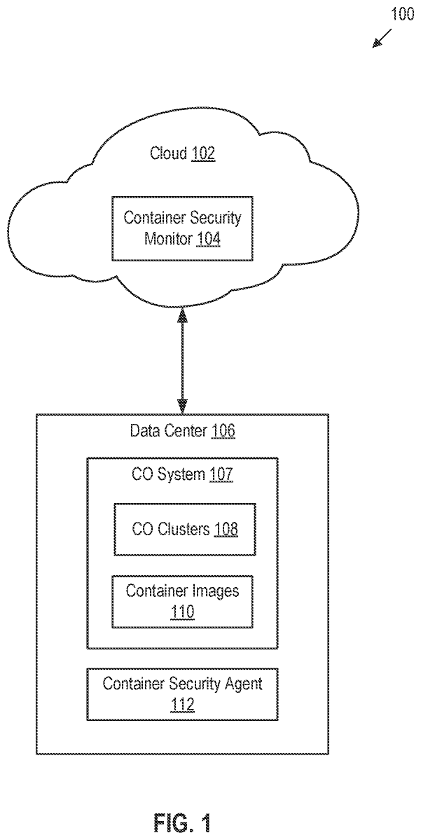

FIG. 1 is a block diagram depicting a computing system 100 according to embodiments. Computing system 100 includes a data center 106 in communication with a cloud 102. A container orchestration (CO) system 107 executes in data center 106. CO system 107 includes CO clusters 108 and container images 110. CO cluster 108 includes a plurality of containers executing therein. The containers are provisioned based on container images 110. In embodiments, CO system 107 comprises a Kubernetes system and CO clusters 108 comprise Kubernetes clusters. However, the techniques described herein can be used with any type of container orchestration system.

A container security monitor 104 executes in cloud 102. In embodiments, container security monitor 104 executes as a software-as-a-service for data center 106. Container security monitor 104 is configured to scan container images 110 for software vulnerabilities. In embodiments, container security monitor 104 cooperates with a container security agent 112 executing in data center 106. In other embodiments, container security monitor 104 can execute in data center 106 rather than as a software-as-a-service in cloud 102. In such an embodiment, container security agent 112 can be present and be cooperating with container security monitor 104, or the functions of container security agent 112 can be incorporated by container security monitor 104. Operation of container security monitor 104 and container security agent 112 are described further below.

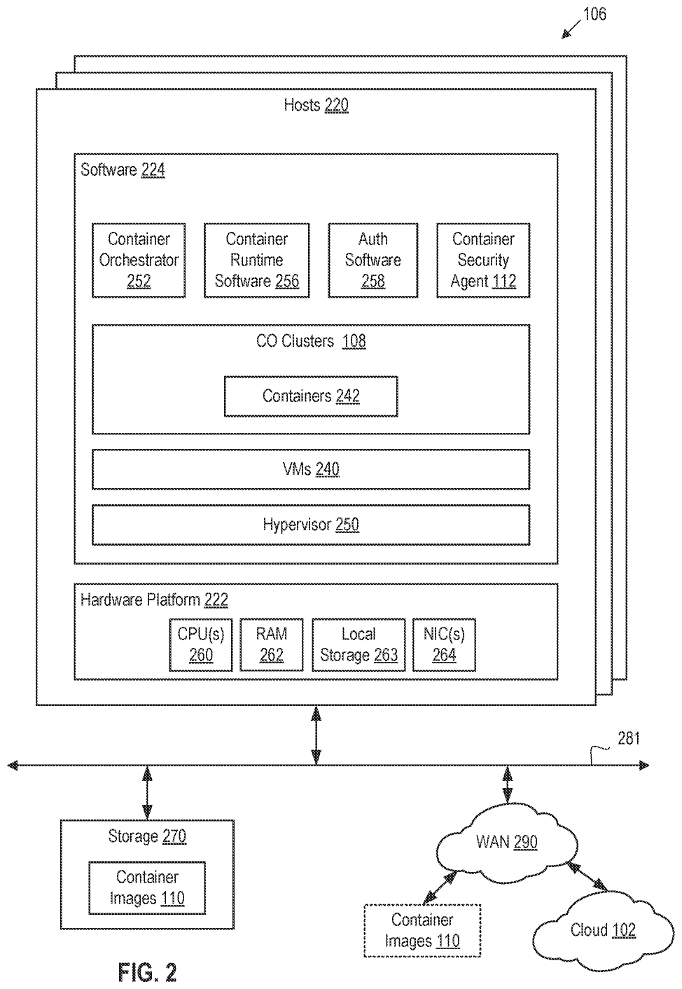

FIG. 2 is a block diagram depicting data center 106 according to embodiments. Data center 106 includes host computers (“hosts 220”). Hosts 220 may be constructed on hardware platforms such as an x86 or ARM architecture platforms. One or more groups of hosts 220 can be managed as clusters. As shown, a hardware platform 222 of each host 220 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 220 to communicate with other devices through a physical network 281. Physical network 281 enables communication between hosts 220 and between other components and hosts 220. In embodiments, storage 270 is coupled to physical network 281 and stores container images 110 (e.g., a container image repository). In embodiments, physical network 281 is coupled to a wide area network (WAN) 290 (e.g., the public Internet) to enable communication with cloud 102 (e.g., communication with cloud security monitor 104). Software can also obtain container images 110 from remote storage through WAN 290.

In embodiments, hosts 220 access storage 270 by using NICs 264 to connect to network 281. In another embodiment, each host 220 contains a host bus adapter (HBA) through which input/output operations (IOs) are sent to shared storage 270 over a separate network (e.g., a fibre channel (FC) network). Storage 270 include one or more storage arrays, such as a storage area network (SAN), network attached storage (NAS), or the like. Storage 270 may comprise magnetic disks, solid-state disks, flash memory, and the like as well as combinations thereof. In some embodiments, hosts 220 include local storage 263 (e.g., hard disk drives, solid-state drives, etc.). Local storage 263 in each host 120 can be aggregated and provisioned as part of a virtual SAN, which is another form of storage 270.

In embodiments, software 224 of each host 220 includes a virtualization layer, referred to herein as a hypervisor 250, which executes on hardware platform 222. Hypervisor 250 abstracts processor, memory, storage, and network resources of hardware platform 222 to provide a virtual machine execution space within which multiple virtual machines (VM) 240 may be concurrently instantiated and executed. CO clusters 108 can execute in VMs 240 or directly on hypervisor 250. In other embodiments, a host 220 can include a host operating system (OS) rather than a hypervisor 250 (e.g., any commodity OS known in the art, such as LINUX). In such an embodiments, CO clusters 108 execute on the host OS. CO clusters 108 include containers 242. Containers 242 provide OS-level virtualization of the underlying OS (e.g., a host OS, hypervisor 250, or a guest OS in a VM 240). Containers 242 are deployed based on container images 110.

Software 224 includes a container orchestrator 252, container runtime software 256, auth software 258, and container security agent 112. Container runtime software 256 is configured to implement the OS-level virtualization of the underlying OS that supports containers 252 (e.g., DOCKER), Container orchestrator 252 is configured to implement higher-level container functionality, including management of CO clusters 108 (e.g., Kubernetes). Auth software 258 is configured to provide authorization and authentication services for users that access container orchestrator 252 and container runtime software 256. In embodiments, a user interacts with container orchestrator 252 and/or container runtime software 256 to create and/or edit container images 110. In embodiments, container security agent 112 hooks into container orchestrator 252 and container runtime software 256. During container image creation or editing, container security agent 112 collects auth data for the user (e.g., username, group name, and like type identity information). Container security agent 112 stores metadata in container images that includes auth data, as described further below.

In embodiments, cloud 102 shown in FIG. 1 can include infrastructure the is the same as or similar to hosts 220. Container security monitor 104 can executes as software on such hosts in cloud 102. Alternatively, as described above, container security monitor 104 can execute in hosts 220 of data center 106.

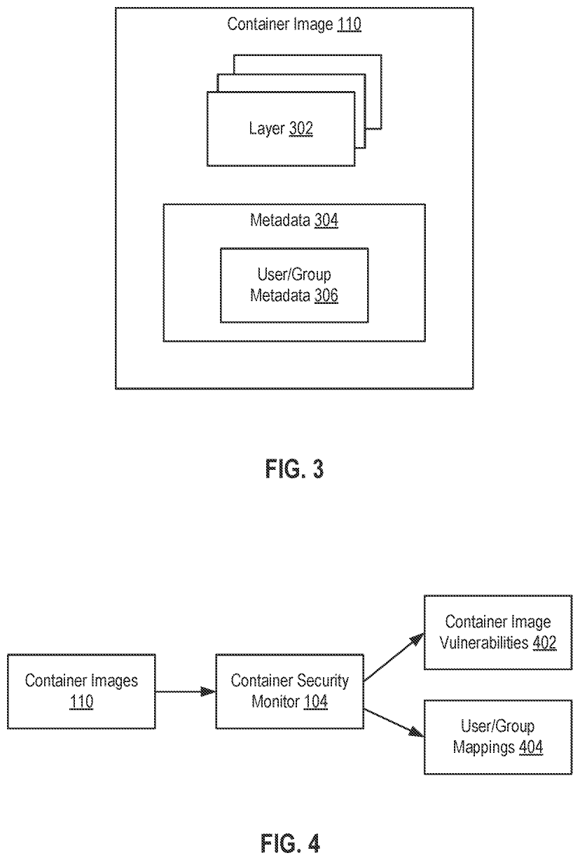

FIG. 3 is a block diagram depicting a container imager 110 according to embodiments. Container image 110 includes a plurality of layers 302. Layers 302 can include a base layer, such as an OS layer. Other layers on top of the base layer add or delete files of lower layers to provide additional software on top of OS layer. Different users and/or groups can be responsible for different layers 302 in container image 110. Container security agent 112 is configured to relate auth data with layers 302 and store user/group metadata 306 in metadata 304 of container image 110. For example if user1 in group1 adds a first layer, user/group metadata 306 relates user1/group1 with the first layer. If a user2 in group2 adds a second layer, user/group metadata 306 relates user2/group2 with the second layer. In some cases, multiple users/groups can be associated with the same layer. In some cases, a single user or group can be associated with multiple layers. In embodiments, container security agent 112 can cooperate with auth software 258 to obtain auth data for the user that modifies container image 110. Container security agent 112 can use this auth data when adding user/group metadata 306 based on the changes made to container image 110.

FIG. 4 is a block diagram depicting logical operation of container security monitor 104 according to embodiments. Container security monitor 104 receives container images 110 to process. In embodiments, container security monitor 104 can receive information on which container images 110 to process from container security agent 112. Container security monitor 104 is configured to scan container images 110 for software vulnerabilities. For example, container security monitor 104 can comprise a version of SYSDIG MONITOR commercially available from Sysdig, Inc. located in San Fransisco, California. Container security monitor 104 identifies container image vulnerabilities 402 and generates user/group mappings 404. For each vulnerability, container security monitor 104 identifies the layer 302 or layers 302 of container image 110 that includes the vulnerability. Using the layer(s), container security monitor 104 identifies, based on metadata 304 in container image 110, user/group metadata associated with the vulnerability. In this manner, container security monitor 104 generates a mapping between each software vulnerability and user(s)/group(s) responsible for the software vulnerability.

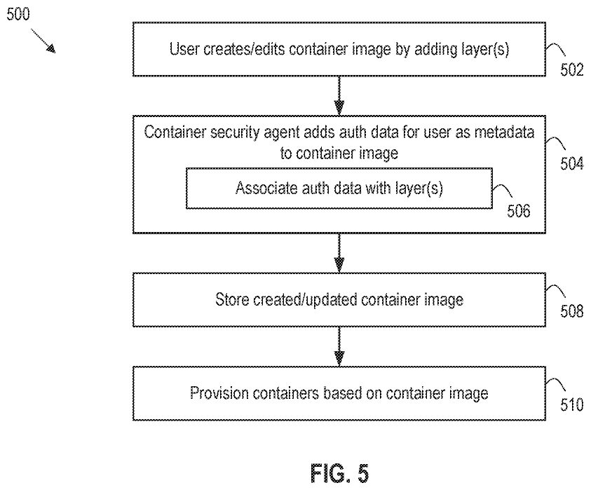

FIG. 5 is a flow diagram depicting a method 500 of creating or editing a container image according to embodiments. Method 500 begins at step 502, where a user creates/edits a container image by adding one or more layers. For example, a user can interact with CO orchestrator 252 and/or container runtime software 256 to create/edit a container image 110. Before interacting with container orchestrator 252 and/or container runtime software 256, the user authenticates with auth software 258. At step 504, container security agent 112 adds auth data for the user as metadata to the container image. The auth data can include various identify information associated with the user (e.g., identity information provided by auth software 256). At step 506, container security agent 112 can associate the auth data with layer(s) of the container image being created/edited.

At step 508, container security agent 112 stores the created/updated container image (e.g., in storage 270). At step 510, CO orchestrator 252 provisions containers in CO cluster 108 based on the container image.

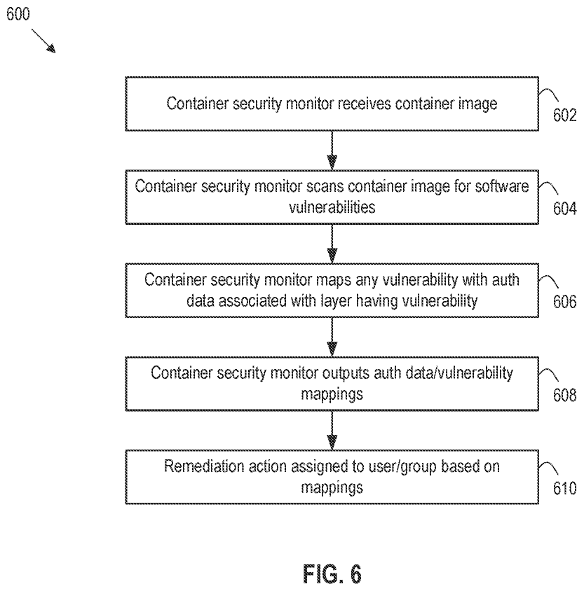

FIG. 6 is a flow diagram depicting a method 600 of processing a container image for software vulnerabilities according to embodiments. Method 600 begins at step 602, where container security monitor 104 receives a container image to be scanned. At step 604, container security monitor 104 scans the container image for software vulnerabilities. At step 606, container security monitor 104 maps any software vulnerability with auth data associated with the layer having the software vulnerability (obtained from user/group metadata 306 in metadata 304 of the container image. At step 608, container security monitor 104 outputs auth data/vulnerability mappings. At step 610, container security monitor 104 or an administer can assign a remediation action to a user/group based on the mappings. In this manner, the remediation action is assigned to the user/group responsible for adding/editing the layer of the container image having the software vulnerability.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing a container image in a computing system, comprising:
adding, by first software executing on a host, metadata associated with a user to the container image, the metadata related to a set of software in the container image;
receiving, by the first software or second software, the container image;
scanning, by the first software or the second software, the container image to identify a software vulnerability;
generating, by the first software or the second software, a mapping between the metadata and the software vulnerability; and
assigning a remediation action to remediate the container image based on the mapping.

2. The method of claim 1, wherein the first software comprises a container security agent executing on the host in a data center, and wherein the second software comprises a container security monitor executing in a cloud in communication with the data center.

3. The method of claim 2, wherein the container security agent notifies the container security monitor of the container image to be scanned.

4. The method of claim 1, wherein the first software comprises a container security monitor executing on the host in a data center.

5. The method of claim 1, wherein the metadata comprises a username and a group name associated with the user, and wherein the first software obtains the metadata in cooperation with auth software.

6. The method of claim 1, wherein the first software relates the metadata with a layer of the container image added by the user.

7. The method of claim 6, wherein the first software or the second software identifies the layer as having the software vulnerability and obtains the metadata from the container image based on the layer.

8. A non-transitory computer readable medium comprising instructions to be executed in a computing device to cause the computing device to carry out a method a method of managing a container image in a computing system, comprising:
adding, by first software executing on a host, metadata associated with a user to the container image, the metadata related to a set of software in the container image;
receiving, by the first software or second software, the container image;
scanning, by the first software or the second software, the container image to identify a software vulnerability;
generating, by the first software or the second software, a mapping between the metadata and the software vulnerability; and
assigning a remediation action to remediate the container image based on the mapping.

9. The non-transitory computer readable medium of claim 8, wherein the first software comprises a container security agent executing on the host in a data center, and wherein the second software comprises a container security monitor executing in a cloud in communication with the data center.

10. The non-transitory computer readable medium of claim 9, wherein the container security agent notifies the container security monitor of the container image to be scanned.

11. The non-transitory computer readable medium of claim 8, wherein the first software comprises a container security monitor executing on the host in a data center.

12. The non-transitory computer readable medium of claim 8, wherein the metadata comprises a username and a group name associated with the user, and wherein the first software obtains the metadata in cooperation with auth software.

13. The non-transitory computer readable medium of claim 8, wherein the first software relates the metadata with a layer of the container image added by the user.

14. The non-transitory computer readable medium of claim 13, wherein the first software or the second software identifies the layer as having the software vulnerability and obtains the metadata from the container image based on the layer.

15. A computing system, comprising:
a host in a data center;
a container security agent executing on the host and configured to add metadata associated with a user to the container image, the metadata related to a set of software in the container image; and
a container security monitor executing in the data center or a cloud in communication with the data center, the container security monitor configured to receive the container image, scan the container image to identify a software vulnerability, generate a mapping between the metadata and the software vulnerability, and assign a remediation action to remediate the container image based on the mapping.

16. The computing system of claim 15, wherein the container security agent notifies the container security monitor of the container image to be scanned.

17. The computing system of claim 15, wherein the first software comprises a container security monitor comprises a software-as-a-service executing in the cloud.

18. The computing system of claim 15, wherein the metadata comprises a username and a group name associated with the user, and wherein the first software obtains the metadata in cooperation with auth software.

19. The computing system of claim 15, wherein the first software relates the metadata with a layer of the container image added by the user.

20. The computing system of claim 19, wherein the first software or the second software identifies the layer as having the software vulnerability and obtains the metadata from the container image based on the layer.
